(19) United States
(12) Patent Application Publication
(10) Pub. No.: US 2021/0372172 A1
(43) Pub. Date: Dec. 2, 2021

(54) BACK-AND-FORTH MOVEMENT DEVICE

(71) Applicant: HI-LEX Corporation, Hyogo (JP)

(72) Inventors: Shohei TANAKA, Hyogo (JO); Yuji INOSE, Tochigi (JP); Hiroshi SONOBE, Tochigi (JP)

(73) Assignee: HI-LEX Corporation, Hyogo (JP)

(21) Appl. No.: 16/759,738

(22) PCT Filed: Oct. 31, 2018
(86) PCT No.: PCT/JP2018/040551

§ 371 Date: Apr. 28, 2020

(30) Foreign Application Priority Data
Oct. 31, 2017 (JP) 2017-210860

(51) Int. Cl. E05B 83/34; B60K 15/05; E05C 5/04

(52) U.S. Cl. CPC E05B 83/34; E05C 5/04; B60K 15/05

(57) ABSTRACT

A back-and-forth movement device includes a guiding section that regulates an operation between a case-side member and a forward/backward member, and a guided section to be guided by the guiding section. In the back-and-forth movement device, a case partly includes a proximate wall portion that is in proximity to the forward/backward member, the guiding section is provided on a side opposite to the forward/backward member with respect to the proximate wall portion, and an engaging section of a restriction member and an extending portion of the guided section extend substantially parallel to each other on the side opposite to the forward/backward member with respect to the proximate wall portion.

### TECHNICAL FIELD

The present invention relates to a back-and-forth movement device including a case and a forward/backward member capable of moving forward and backward with respect to the case.

### BACKGROUND ART

In vehicles, such as automobiles, back-and-forth movement devices each configured to move a forward/backward member forward and backward between a pushed-in position where a fuel lid is closed and a pushed-out position where the fuel lid is opened have been used in opening/closing apparatuses for fuel lids each covering a filler port (e.g., see, Patent Literature (hereinafter, referred to as “PTL”) 1).

In this back-and-forth movement device, a lock portion is provided in a position adjacent to the forward/backward member so as to engage with the forward/backward member and thereby to restrict movement of the forward/backward member, and a drive section for rotating a worm wheel which moves this lock portion is provided on a side opposite to the forward/backward member with respect to this worm wheel. Thus, the back-and-forth movement device has a flat structure and, therefore, is easily housed in a flat rectangular housing portion.

### CITATION LIST

### Patent Literature

### PTL 1

### Japanese Patent Application Laid-Open No. 2016-142040

### SUMMARY OF INVENTION

### Technical Problem

In the meantime, it has been recently considered to make a back-and-forth movement device that is still thinner in the thickness direction and still flatter than the back-and-forth movement device described above, and to provide the thinner and flatter back-and-forth movement device in a rectangular housing portion that is still flatter and thinner than the conventional housing portion.

An object of the present invention is to provide a back-and-forth movement device capable of being housed even in a narrow housing space that is flat and thin in the thickness direction.

### Solution to Problem

A back-and-forth movement device of the present invention includes:

a case;

a drive section;

a forward/backward member capable of moving forward and backward with respect to the case;

a forward/backward position control mechanism that performs control such that the forward/backward member moves forward to a forward position or backward to a backward position, the forward position being where the forward/backward member has moved forward with respect to the case, the backward position being where the forward/backward member has moved backward with respect to the case; and

a restriction member that brings the forward/backward member into a restricted state in which forward/backward movement is restricted; in which

the forward/backward member is provided in the case so as to move forward and backward while rotating relatively with respect to the case,

the forward/backward position control mechanism includes a forward/backward-member-side member, a guiding section, and a guided section, the forward/backward-member-side member being provided on the forward/backward member so as to be fitted rotatably relative to the forward/backward member, the guiding section being configured to regulate an operation of relative movement between the forward/backward-member-side member and the case, the guided section being guided by the guiding section,

the forward/backward member is moved to the forward position or the backward position, respectively, when the guided section is guided to a first position or a second position in the guiding section, and

the restriction member is provided so as to be movable to a restricted position where the forward/backward member is brought into the restricted state and to a release position where the restricted state is released, the restriction member being configured to be engaged with the forward/backward-member-side member in the restricted position to bring the forward/backward member into the restricted state,

the guiding section is provided in the forward/backward-member-side member,

the guided section includes a fixed portion at least partially fixed to the case, and an extending portion extending to the guiding section,

the restriction member includes an engaging section that is engaged with an engaged section in the restricted position, the engaged section being provided in the forward/backward-member-side member;

the case partly includes a proximate wall portion that is in proximity to the forward/backward member,

the guiding section is provided on a side opposite to the forward/backward member with respect to the proximate wall portion, and

the engaging section of the restriction member and the extending portion of the guided section extend substantially parallel to each other on the side opposite to the forward/backward member with respect to the proximate wall portion.

### Advantageous Effects of Invention

According to the present invention, a back-and-forth movement device capable of being housed even in a narrow housing space which is thin in the thickness direction can be provided.

### BRIEF DESCRIPTION OF DRAWINGS

FIG. 1 is a perspective view of a configuration in which a back-and-forth movement device according to an embodiment of the present invention is applied to a fuel lid opening/closing apparatus;

FIG. 2 is a diagram for describing the relationship between a latching section of a forward/backward member and a latched section of a fuel lid;

FIG. 3 is a side view schematically illustrating an attached state of the back-and-forth movement device in the opening/closing apparatus;

FIG. 4 is a front view of the back-and-forth movement device according to the embodiment of the present invention;

FIG. 5 is a front view of a configuration of principal parts of the back-and-forth movement device according to the embodiment of the present invention;

FIG. 6 illustrates a state in which the forward/backward member is moved backward in FIG. 5;

FIG. 7 is a perspective view of the forward/backward member;

FIG. 8 is a rear perspective view of a forward/backward-member-side member;

FIG. 9 is an enlarged perspective view illustrating a configuration of principal parts of a forward/backward position control mechanism of the back-and-forth movement device according to the embodiment of the present invention;

FIG. 10 is a front view illustrating the inner structure of the back-and-forth movement device in which forward/backward movement is restricted by a restriction member in FIG. 6;

FIG. 11 is a bottom view schematically illustrating an arrangement relationship of components in the back-and-forth movement device according to the embodiment of the present invention; and

FIG. 12 is a side view schematically illustrating the arrangement relationship of the components in the back-and-forth movement device according to the embodiment of the present invention.

### DESCRIPTION OF EMBODIMENTS

An embodiment of the present invention will be described below in detail with reference to the drawings.

The back-and-forth movement device of the present embodiment moves the forward/backward member forward and backward with respect to the case, and can be disposed in a rectangular narrow housing space that is flat and thinly defined in the thickness direction. In the present embodiment, a fuel lid opening/closing apparatus is given as one application example, but the forward/backward moving device of the present embodiment may also be applied to an apparatus different from the fuel lid opening/closing apparatus.

[Opening/Closing Apparatus 100 to which Back-and-Forth Movement Device 1 is Applied]

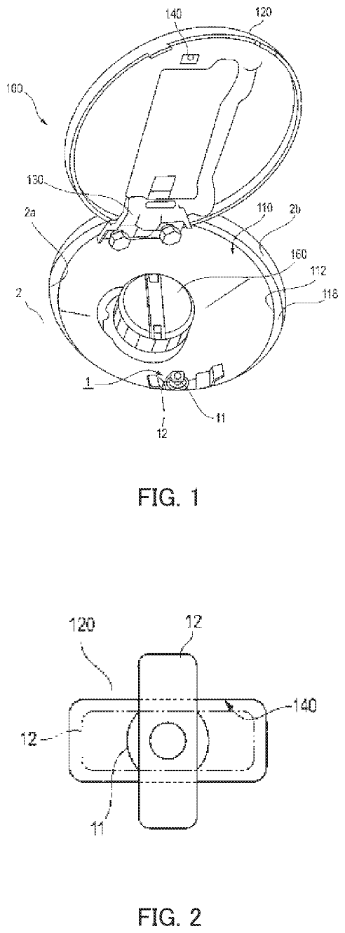

As illustrated in FIG. 1, opening/closing apparatus 100 is an apparatus that opens and closes a lid for an opening that houses a filler port of a vehicle, and back-and-forth movement device 1 according to the present embodiment is applied to this opening/closing apparatus 100. Opening/closing apparatus 100 is a so-called fuel inlet box and is an apparatus to be installed in filler opening portion 2a of vehicle body 2 for pumping fuel into a fuel tank of the vehicle.

Opening/closing apparatus 100 includes: box main body 110 to be attached to filler opening portion 2a of vehicle body 2; fuel lid 120 which is a lid for covering filler opening portion 2a; hinge 130 that supports fuel lid 120 such that fuel lid 120 can pivot; and back-and-forth movement device 1.

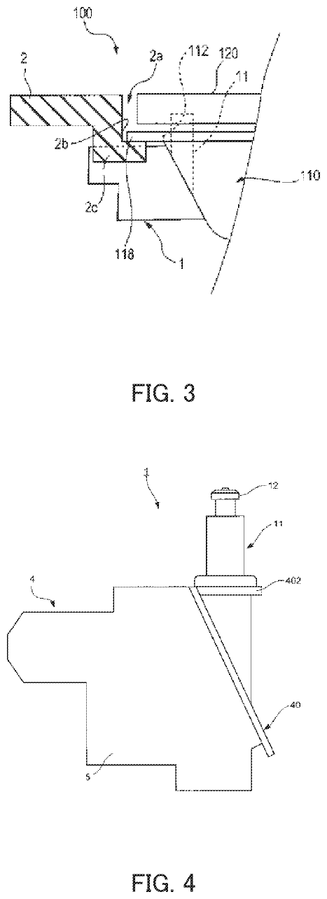

Box main body 110 is attached to filler opening portion 2a to form a fueling chamber that surrounds a filler tube on a side of the filler port. Box main body 110 illustrated in FIG. 1 and FIG. 3 is formed cylindrically, and has two openings (only one opening 112 is illustrated in FIG. 3), one opening 112 of which is continuously attached to filler opening portion 2a, and one end portion of the filler tube (not illustrated) is fittingly inserted into the other one (not illustrated) of the two openings. One end portion of the filler tube is disposed so as to protrude into box main body 110 and has a filler opening. As illustrated in FIG. 1, the filler opening is closed by screw cap 160. Screw cap 160 is removable at the time of refueling.

Flange 118 is provided at an edge portion of opening 112 of box main body 110, and this flange 118 is fixed to a circumferential edge portion of filler opening portion 2a. In the present embodiment, the circumferential edge portion of filler opening portion 2a is annular surface portion 2c (see FIG. 3) situated in such a manner as to be recessed inward from the outer surface of vehicle body 2 to form step 2b with respect to the outer surface of vehicle body 2. Flange 118 is attached to this annular surface portion 2c from the outside of the vehicle body.

The outer peripheral surface of box main body 110 between one opening 112 and the other opening is partially inclined with respect to filler opening portion 2a. In the present embodiment, box main body 110 is a truncated cone-shaped tube, and is formed such that an outer circumference of box main body 110 increases in diameter from the opening on the side of the filler tube toward opening 112 on the side of filler opening portion 2a. Back-and-forth movement device 1 is provided on a part of this inclined outer peripheral surface such that forward/backward member 11 is movable forward and backward in an oblique direction inside of the inclined surface. Back-and-forth movement device 1 is of such a shape that box main body 110 to which back-and-forth movement device 1 is attached is allowed to be inserted without being caught by filler opening portion 2a while back-and-forth movement device 1 is first placed into substantially circular filler opening portion 2a. Moreover, when attached to filler opening portion 2a, back-and-forth movement device 1 is disposed in a state of being housed in the rectangular narrow housing portion that is flat and thinly defined in the thickness direction.

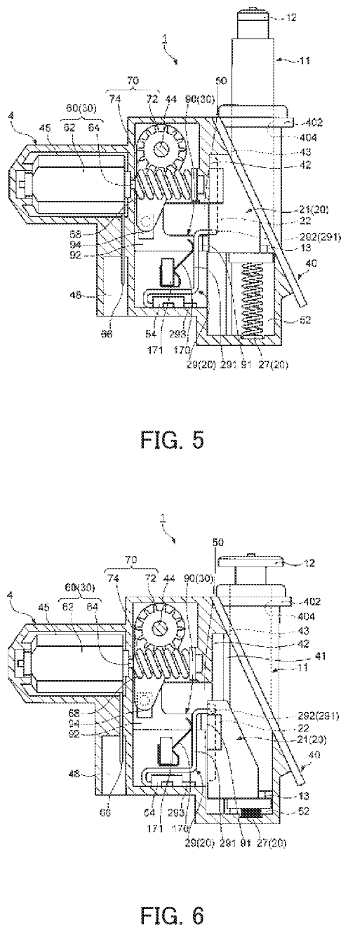

As illustrated in FIG. 1 to FIG. 6, back-and-forth movement device 1 includes forward/backward member 11, and latching section 12 disposed on a leading end of forward/backward member 11, and forward/backward member 11 moves forward and backward to open and close fuel lid 120. Note that, FIG. 5 and FIG. 6 illustrate back-and-forth movement device 1 with cover 5 removed in order to illustrate the inner configuration of back-and-forth movement device 1. In FIG. 5 and FIG. 6, a part of back-and-forth movement device 1 to which cover 5 is attached is indicated by hatching for convenience.

Fuel lid 120 is provided with latched section 140 onto which latching section 12 of forward/backward member 11 can be latched (see FIG. 1 and FIG. 2). Latched section 140 is, for example, a hole having an opening portion through which latching section 12 can pass when latching section 12 is in a predetermined angular position.

[Operation of Opening/Closing Apparatus 100 to which Back-and-Forth Movement Device 1 is Applied]

According to opening/closing apparatus 100 configured in the manner described above, when fuel lid 120 is closed, fuel lid 120 pushes forward/backward member 11, and forward/backward member 11 moves backward toward the inner side of vehicle body 2. When fuel lid 120 is closed and comes into contact with latching section 12, latching section 12 of forward/backward member 11 is in the predetermined angular position (see latching section 12 illustrated with imaginary line in FIG. 2) and therefore passes through the opening portion of latched section 140 and enters latched section 140. Further, when forward/backward member 11 moves backward, latching section 12 positioned inside of latched section 140 rotates and the angle of latching section 12 changes (see latching section 12 indicated by the solid line in FIG. 2), so that latching section 12 is latched onto the inner surface of latched section 140. When latching section 12 is latched onto latched section 140, fuel lid 120 in a closed state is locked.

When fuel lid 120 is pushed in the state where filler opening portion 2a is closed by fuel lid 120, a biasing force acts on forward/backward member 11, and forward/backward member 11 moves forward to the outer side of vehicle body 2. At this time, when latching section 12 of forward/backward member 11 rotates and the angular position of latching section 12 becomes the predetermined angular position, latching between latching section 12 and latched section 140 is released. Fuel lid 120 is thus operated to open.

In a restricted state where the forward/backward movement of back-and-forth movement device 1 is restricted, which will be described later, no biasing force that causes forward/backward member 11 to move forward to the outer side of vehicle body 2 is applied to forward/backward member 11 even when fuel lid 120 is pushed further when fuel lid 120 is closed. Thus, fuel lid 120 does not open.

[Overall Configuration of Back-and-Forth Movement Device 1]

As illustrated in FIG. 5 and FIG. 6, back-and-forth movement device 1 includes case 4 partly having proximate wall portion 40, forward/backward member 11, and restriction mechanism 30. Note that, FIG. 5 illustrates a state in which forward/backward member 11 has moved forward to a forward position, and FIG. 6 illustrates a state in which forward/backward member 11 has moved backward to a backward position.

Back-and-forth movement device 1 moves forward/backward member 11 forward and backward in a direction that is oblique with respect to the extending direction of proximate wall portion 40. Forward/backward member 11 moves forward/backward in a direction at an angle with respect to the normal to the surface of proximate wall portion 40. In back-and-forth movement device 1 of the present embodiment, forward/backward member 11 is inserted through proximate wall portion 40 and moves forward and backward. Back-and-forth movement device 1 locks, by restriction mechanism 30, forward/backward member 11 that moves forward and backward with respect to case 4. Forward/backward member 11 of back-and-forth movement device 1 is capable of moving forward and backward by forward/backward position control mechanism 20. Further, restriction mechanism 30 includes drive section 60, rotary gear 72, swing member 74, and restriction member 90. Note that, swing member 74 and restriction member 90 constitute a link mechanism in which the rotation of rotary gear 72 causes restriction member 90 to move rectilinearly.

[Case 4]

As illustrated in FIG. 5 and FIG. 6, case 4 includes a plurality of holding sections for holding components of forward/backward member 11, forward/backward position control mechanism 20, and restriction mechanism 30 such that those components have below-described respective positional relationships with one another. Case 4 herein includes an opening to be covered by cover 5. The components to be assembled inside of case 4, such as forward/backward member 11 and the like, are housed inside of case 4 through this opening. Cover 5 is placed over the opening after required components are housed and assembled inside of case 4 (see FIG. 3). Note that, the components of forward/backward position control mechanism 20 include components such as forward/backward-member-side member 21, spring 27 serving as a biasing member, bending pin 29 as an example of a guided section, and the like. Further, the components of restriction mechanism 30 include components such as drive section 60, rotary gear 72, swing member 74, and restriction member 90, and the like.

As illustrated in FIG. 5 and FIG. 6, case 4 is partly provided with proximate wall portion 40 that is in proximity to forward/backward member 11. In the present embodiment, proximate wall portion 40 is one side portion of both side wall portions that are separated from each other in the width direction of laterally long case 4 that is long in the width direction.

Proximate wall portion 40 is provided so as to be inclined with respect to wall portions of case 4 disposed to be separated from each other and to face each other in the extending direction of forward/backward member 11, which is here the perpendicular direction.

Through-hole 43 through which a part of forward/backward member 11 passes is provided in proximate wall portion 40 such that forward/backward member 11 is capable of moving forward and backward with respect to case 4.

Through-hole 43 is provided to extend through proximate wall portion 40 in a direction parallel to the perpendicular direction of case 4. Forward/backward member 11 passing through through-hole 43 moves forward and backward in a direction that is oblique with respect to the extending direction of proximate wall portion 40.

Proximate wall portion 40 includes, at its end on the forward position side of forward/backward member 11, extending portion 402 that extends in a direction intersecting the forward/backward direction of forward/backward member 11, which is here a direction orthogonal to the forward/backward direction of forward/backward member 11.

Extending portion 402 is provided with through-hole 404. Forward/backward member 11 passing through through-hole 43 is inserted into through-hole 404 so as to freely move forward and backward. Through-hole 404 and through-hole 43 communicate with each other by a cylindrical portion through which forward/backward member 11 can be inserted.

In case 4, in a case where the opening over which cover 5 is placed is considered as the upper portion, the bottom portion, and wall-like portions, protrusions and recesses provided upright on or in the bottom portion form the holding sections and the like (i.e., forward/backward-member holding section 41, forward/backward-member-side-member holding section 42, drive-section-main-body holding section 45, lead-out hole 48, link holding section 50, spring housing section 52, and guided-section holding section 54) by which forward/backward member 11 and the components of restriction mechanism 30 such as restriction member 90 and the like are held. Lead-out hole 48 is hole 48 for leading out a wire (illustration is omitted) to be connected to terminal 66.

As illustrated in FIG. 6, forward/backward-member holding section 41 holds forward/backward member 11 such that forward/backward member 11 is movable in a predetermined direction in case 4. Forward/backward-member holding section 41 is disposed along the bottom portion of case 4 in the present embodiment. Forward/backward-member holding section 41 holds forward/backward member 11 such that forward/backward member 11 is movable forward and backward to the outside of case 4 through through-hole 43 in proximate wall portion 40.

Forward/backward-member-side-member holding section 42 holds a part of forward/backward-member-side member 21 such that forward/backward-member-side member 21 is slidable.

Forward/backward-member-side-member holding section 42 is disposed in case 4 in such a position as to face proximate wall portion 40 with forward/backward-member holding section 41 interposed therebetween.

Forward/backward-member-side-member holding section 42, together with forward/backward-member holding section 41 and spring housing section 52, forms a forward/backward movement space for the forward/backward movement of forward/backward member 11 and forward/backward-member-side member 21 in case 4.

Drive-section-main-body holding section 45 holds drive-section main body 62 of drive section 60 in a direction in which drive shaft 64 is orthogonal to the forward/backward direction of forward/backward member 11.

Drive-section-main-body holding section 45 is provided to extend in a direction orthogonal to the forward/backward direction of forward/backward member 11 (that is, drive-section-main-body holding section 45 extends in the width direction) with respect to link holding section 50 and provided adjacently to link holding section 50 on the side opposite to forward/backward member 11.

Link holding section 50 holds swing member 74 such that swing member 74 is swingable, and holds restriction member 90 such that restriction member 90 is slidable.

Link holding section 50 holds the link mechanism. In the present embodiment, link holding section 50 is disposed between forward/backward-member-side-member holding section 42 and drive-section-main-body holding section 45 to be adjacent to forward/backward-member-side-member holding section 42 and drive-section-main-body holding section 45. Link holding section 50 includes spindle 44 provided on the bottom portion of case 4, and holds swing member 74 using spindle 44 such that swing member 74 is swingable. Link holding section 50 holds restriction member 90 on the side closer to the bottom surface of case 4 than a swing region of swing member 74 is to the bottom surface such that restriction member 90 is freely slidable toward the side of forward/backward-member-side-member holding section 42.

Spring housing section 52 houses spring 27 therein. Spring housing section 52 is continuously disposed in case 4 on the backward position side of forward/backward-member holding section 41. Spring 27 is disposed so as to be positioned along the forward/backward direction of forward/backward member 11. In spring housing section 52, spring 27 is installed between one of the wall portions separated from each other in the perpendicular direction of case 4 which is situated on the rear end position side of forward/backward member 11, on the one hand, and the rear end portion of forward/backward member 11, on the other hand. Note that, spring 27 may also be disposed in spring housing section 52 in such a manner as to be partially inserted into forward/backward member 11 through an opening provided in the rear end of forward/backward member 11 and connected at its end to a spring seat provided inside of forward/backward member 11. In the present embodiment, spring housing section 52 is configured such that the rear end side of forward/backward member 11 having moved backward is housed in spring housing section 52.

Guided-section holding section 54 fixes at least a part of bending pin 29 that is an example of the guided section. In the present embodiment, guided-section holding section 54 is disposed to be adjacent to both of link holding section 50 and spring housing section 52. As illustrated in FIG. 5, this section is a region that is adjacent to link holding section 50 and spring housing section 52 when link holding section 50 and forward/backward-member holding section 41 from which spring housing section 52 continues on the backward position side are disposed to be adjacent to each other in the forward/backward direction of forward/backward member 11, that is, in the width direction of back-and-forth movement device 1.

With this configuration, forward/backward member 11 and forward/backward-member-side member 21 provided on the side of forward/backward member 11 are movable without rattling with case 4 due to forward/backward-member holding section 41 and forward/backward-member-side-member holding section 42. Accordingly, movement of forward/backward-member-side member 21 at a predetermined position can be regulated by restriction mechanism 90 held by link holding section 50.

Further, in the present embodiment, forward/backward-member-side-member holding section 42, link holding section 50, and drive-section-main-body holding section 45 are disposed along a direction orthogonal to the direction in which forward/backward-member holding section 41 and spring housing section 52 are aligned (that is, the forward/backward direction of forward/backward member 11).

Lead-out hole 48 is disposed on the side opposite to forward/backward-member-side-member holding section 42 with respect to link holding section 50 and adjacently to drive-section-main-body holding section 45 and link holding section 50. Lead-out hole 48 has a length extending in a direction containing the forward/backward direction as a directional component. In the present embodiment, lead-out hole 48 is provided to extend substantially parallel to the forward/backward direction, and leads out a wire connected to terminal 66 while guiding the wire parallel to the forward/backward direction.

As described above, forward/backward-member-side-member holding section 42 is adjacent to spring housing section 52 and link holding section 50 is adjacent to guided-section holding section 54 in case 4. Drive-section-main-body holding section 45 is disposed on the side opposite to forward/backward-member-side-member holding section 42 with respect to link holding section 50 and adjacently to link holding section 50. Further, in the present embodiment, lead-out hole 48 is disposed on the side opposite to spring housing section 52 with respect to guided-section holding section 54 and adjacently to guided-section holding section 54. Case 4 has a configuration in which the relationship between forward/backward-member-side-member holding section 42, guided-section holding section 54, link holding section 50, drive-section-main-body holding section 45, and spring housing section 52 adjacent to one another allows case 4 to be longer in the width direction than in the perpendicular direction and thinner.

[Forward/Backward Member 11]

Forward/backward member 11 is a member capable of moving forward and backward with respect to case 4. More specifically, forward/backward member 11 is movable to the forward position where forward/backward member 11 has moved forward and to the backward position where forward/backward member 11 has moved backward. Here, the term “moving forward” refers to a movement toward the outer side of case 4, and the term “moving backward” refers to a movement toward the inner side of case 4. Further, the term “forward position” is a stop position of forward/backward member 11 having moved forward (see FIG. 5), and the term “backward position” is a stop position of forward/backward member 11 having moved backward (see FIG. 6). Accordingly, when both of the forward position and the backward position are outside of case 4 as in the present embodiment, for example, a specific portion of forward/backward member 11, e.g., the leading end of forward/backward member 11 is more distant from case 4 in the forward position than in the backward position.

In opening/closing apparatus 100 (see FIG. 1), the forward position is a position where latching section 12 and latched section 140 of fuel lid 120 are in an unlatched state, and fuel lid 120 is thus in an open state. Further, in opening/closing apparatus 100, the backward position is a position where latching section 12 and latched section 140 of fuel lid 120 are in a latched state, and fuel lid 120 is thus held in a closed state.

Note that, as a variation, it is conceivable that the forward position and the backward position are both inside of case 4. In this case, the specific portion of forward/backward member 11, for example, the leading end of forward/backward member 11 is nearer to the outside of case 4 than in the backward position. It is further conceivable that the forward position is outside of case 4 and the backward position is inside of case 4. In this case, the specific portion of forward/backward member 11, for example, the leading end of forward/backward member 11 comes out of and goes in case 4.

Forward/backward member 11 is provided in case 4 so as to move forward and backward while rotating relatively with respect to case 4.

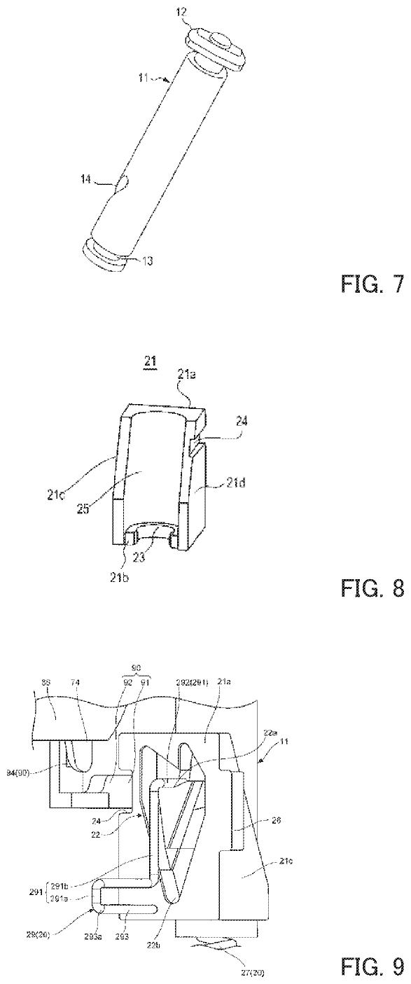

In the present embodiment, forward/backward member 11 includes a circular columnar or cylindrical rod part, and latching section 12 provided on the leading end of the rod part. In the present embodiment, forward/backward member 11 is disposed such that the axial direction of forward/backward member 11 coincides with the direction in which forward/backward member 11 moves forward and backward (forward direction and backward direction). As illustrated in FIG. 5 to FIG. 7, annular groove 13 is formed in an axially partial portion of the rod part. Annular groove 13 is an example of a fitted section to which forward/backward-member-side member 21 to be described later is fitted in a relatively rotatable manner. In the present embodiment, annular groove 13 is provided on the rear end side of the rod part, and helical groove 14 is provided in a portion of the rod part on the leading end side relative to annular groove 13. Annular groove 13 is provided in the outer periphery of the rod part orthogonally to the axis of forward/backward member 11. Annular groove 13, which is the fitted section, is provided in order to prevent forward/backward-member-side member 21 from being displaced and hindering the restriction imposed by restriction member 90 when forward/backward member 11 rotates around the axis thereof.

Forward/backward member 11 is inserted into through-hole 43 in proximate wall portion 40 and through-hole 404 in extending portion 402, and is held slidably in a direction that is oblique with respect to proximate wall portion 40 by forward/backward-member holding section 41 of case 4. Forward/backward-member holding section 41 is provided with a wall surface (a wall surface of case 4 on the bottom side in the present embodiment) for holding forward/backward member 11, and the wall surface is provided with a protrusion (not illustrated). Forward/backward member 11 is disposed such that the protrusion on the wall surface of case 4 on the bottom side is inserted into helical groove 14. Note that, the bottom side of case 4 corresponds to the side of case 4 opposite to the side where cover 5 is attached. Further, forward/backward member 11 is restricted from moving in the direction orthogonal to the axial direction by forward/backward-member-side member 21 (see FIG. 5), cover 5, and the wall surface of case 4, so that the protrusion is prevented from coming out of helical groove 14. Accordingly, when forward/backward member 11 moves in the forward/backward direction, forward/backward member 11 rotates about the axial core since the position of helical groove 14 in the circumferential direction is restrained by the protrusion. That is, as an example of the forward/backward movement performed while rotating relatively with respect to case 4, forward/backward member 11 moves forward and backward while rotating about the axial core.

The protrusion of forward/backward-member holding section 41 and helical groove 14 in forward/backward member 11 form a mechanism through which forward/backward member 11 moves forward and backward while rotating relatively with respect to case 4. Helical groove 14 in forward/backward member 11 is an example of a trajectory guiding section that guides forward/backward member 11 along the trajectory of the rotational movement of forward/backward member 11, and the protrusion of forward/backward-member holding section 41 is an example of a trajectory guided section to be guided by the trajectory guiding section. As a variation, forward/backward-member holding section 41 may also be provided with the trajectory guiding section such as the helical groove, and forward/backward member 11 may also be provided with the trajectory guided section such as the protrusion. That is, it is possible to employ a configuration in which one of case 4 and forward/backward member 11 includes the trajectory guiding section that guides the movement trajectory of forward/backward member 11 such that forward/backward member 11 moves forward and backward while rotating relatively with respect to case 4, and the other one of case 4 and forward/backward member 11 includes the trajectory guided section to be guided by the trajectory guiding section.

Note that, in the present embodiment, as an example of the behavior of forward/backward member 11 of moving forward and backward while rotating relatively with respect to case 4, continuous rotation associated with forward/backward movement of forward/backward member 11 has been mentioned, but another behavior is also conceivable. For example, the behavior of forward/backward member 11 may also be temporary rotation or intermittent rotation of forward/backward member 11 in the course of the forward/backward movement of forward/backward member 11 or at the start or at the end of the forward/backward movement.

[Overall Configuration of Forward/Backward Position Control Mechanism 20]

Forward/backward position control mechanism 20 is a mechanism that performs control such that forward/backward member 11 moves forward to the forward position where forward/backward member 11 has moved forward with respect to case 4, or moves backward to the backward position where forward/backward member 11 has moved backward with respect to case 4.

Forward/backward position control mechanism 20 includes forward/backward-member-side member 21, guiding section 22 that regulates relative movement between case 4 and forward/backward-member-side member 21, bending pin 29 guided by guiding section 22, and spring 27.

Forward/backward position control mechanism 20 has a movement function of moving forward/backward member 11 in the forward/backward direction and a stop function of stopping forward/backward member 11 in the forward position or the backward position.

The movement in the forward/backward direction, the forward position, and the backward position of forward/backward member 11 are all determined based on the relative positional relationship with case 4. Therefore, forward/backward position control mechanism 20 includes a part provided on forward/backward member 11 (that is, forward/backward-member-side member 21) and bending pin 29 partially fixed to case 4 as a part provided on case 4, which are configured to make it possible for forward/backward position control mechanism 20 to control the positional relationship between forward/backward member 11 and case 4. In addition, guiding section 22 is provided in forward/backward-member-side member 21 which is a part provided on forward/backward member 11 in the present embodiment. All of these are disposed in case 4.

[Forward/Backward-Member-Side Member 21]

Forward/backward-member-side member 21 illustrated in FIG. 5, FIG. 6, and FIG. 8 is provided on forward/backward member 11 so as to be fitted rotatably relative to forward/backward member 11. Forward/backward-member-side member 21 moves along with forward/backward member 11 in the axial direction of forward/backward member 11. In the present embodiment, although forward/backward-member-side member 21 is a member different from forward/backward member 11, forward/backward-member-side member 21 is provided on forward/backward member 11 and functions as a part of forward/backward member 11. Moreover, forward/backward-member-side member 21 has recess portion 24 as an example of an engaged section that is engaged with restriction member 90 in the present embodiment.

Forward/backward-member-side member 21 includes first plate-shaped section 21a that extends horizontally along the axis of forward/backward member 11 and includes guiding section 22, and second plate-shaped section 21b that extends from first plate-shaped section 21a in a direction perpendicular to the axis of forward/backward member 11, as illustrated in FIG. 8, FIG. 9, and the like.

Second plate-shaped section 21b includes C-shaped fitting section 23 as illustrated in FIG. 8, and fitting section 23 is fitted to annular groove 13 in forward/backward member 11 as illustrated in FIG. 5 to FIG. 7. Second plate-shaped section 21b therefore slides along annular groove 13 in the direction about the axis of forward/backward member 11, but the relative movement of forward/backward member 11 and second plate-shaped section 21b to each other in the axial direction of forward/backward member 11 and in the direction orthogonal to the axial direction is regulated. Therefore, forward/backward member 11 and forward/backward-member-side member 21 are relatively rotatable in the rotation direction about the axial core of forward/backward member 11 while being unable to move relatively with respect to each other in the axial direction of forward/backward member 11.

Further, third plate-shaped section 21c is provided in forward/backward-member-side member 21 so as to intersect first plate-shaped section 21a and second plate-shaped section 21b at right angles, and fourth plate-shaped section 21d is provided in forward/backward-member-side member 21 so as to intersect first plate-shaped section 21a and second plate-shaped section 21b at right angles and to face third plate-shaped section 21c.

Each of third plate-shaped section 21c and fourth plate-shaped section 21d includes a tapered portion at its leading end side, that is, at its edge portion situated on the forward side in the forward/backward direction of forward/backward member 11 in order that, when forward/backward member 11 moves forward, the tapered portions come into contact with the inner wall surface around through-hole 43 of proximate wall portion 40 situated obliquely with respect to the forward/backward direction. In the present embodiment, forward/backward-member-side member 21 makes contact with proximate wall portion 40 at the tapered portions of third plate-shaped section 21c and fourth plate-shaped section 21d situated at their edge portions on the leading end side. Accordingly, the forward movement of forward/backward member 11 to which forward/backward-member-side member 21 is attached is regulated. The tapered portions of third plate-shaped section 21c and fourth plate-shaped section 21d situated at their edge portions on the leading end side may be arranged substantially in parallel with proximate wall portion 40 situated obliquely with respect to the forward/backward direction. Annular groove 13 may also be provided in such a position that it is not possible that these tapered portions of forward/backward-member-side member 21 come into contact with proximate wall portion 40 to hinder the forward movement of forward/backward member 11 when forward/backward member 11 moves forward. In the present embodiment, since annular groove 13 is provided in the rear end portion of forward/backward member 11 and the tapered portions are provided, it is possible to ensure a sufficient stroke of forward/backward member 11 even when proximate wall portion 40 obliquely extends with respect to forward/backward member 11 as if to divide forward/backward member 11 and substantially the half of forward/backward member 11 is inside of case 4.

When fitting section 23 is fitted in annular groove 13, forward/backward-member-side member 21 is attached onto forward/backward member 11 such that forward/backward member 11 is surrounded with first plate-shaped section 21a, third plate-shaped section 21c, and fourth plate-shaped section 21d in the circumferential direction. Further, forward/backward-member-side member 21 is provided with curved surface 25 having a shape that follows the outer surface of the rod part of forward/backward member 11. Forward/backward-member-side member 21 and forward/backward member 11 relatively rotate with respect to each other in a state where curved surface 25 follows the outer surface of the rod part of forward/backward member 11. Accordingly, rotation without rattling can be achieved. The position of second plate-shaped section 21b having fitting section 23 in forward/backward-member-side member 21 may be any position as long as third plate-shaped section 21c and fourth plate-shaped section 21d can come into contact with the inner wall surface around through-hole 43 in case 4 when forward/backward-member-side member 21 moves in accordance with the forward movement of forward/backward member 11. In the present embodiment, fitting section 23 is disposed on the rear end portion of forward/backward-member-side member 21 in the forward/backward direction of forward/backward member 11 and is freely turnably fitted in the rear end portion of forward/backward member 11. It is thus possible to make longer the possible stroke length of the forward/backward movement through through-hole 43 than in the structure in which forward/backward-member-side member 21 is fitted in the rod part of forward/backward member 11 at the leading end side of the rod part.

Note that, the fitting structure of forward/backward member 11 and forward/backward-member-side member 21 may be any structure as long as these members are relatively rotatable about the axial core of forward/backward member 11. For example, forward/backward member 11 may be provided with an annular protrusion, and forward/backward-member-side member 21 may be provided with an annular groove in which the annular protrusion is fitted. The annular protrusion may be replaced with a plurality of protrusions. Forward/backward-member-side member 21 and forward/backward member 11 are not particularly limited to specific shapes as long as forward/backward member 11 is fitted to forward/backward-member-side member 21 such that forward/backward-member-side member 21 is movable together with forward/backward movement of forward/backward member 11 in the axial direction and forward/backward member 11 is relatively rotatable with respect to forward/backward-member-side member 21 while movement of forward/backward member 11 is restricted in a case where movement of forward/backward-member-side member 21 is restricted. The fitting section of forward/backward-member-side member 21 and the fitted section of forward/backward member 11 are readily attachable to one another when one of the fitting section and the fitted section has an annular shape.

Third plate-shaped section 21c of forward/backward-member-side member 21 has protruding portion 26 protruding from the outer surface thereof. Protruding portion 26 is disposed in a guiding groove (not illustrated) which is linearly provided in the back surface of cover 5 to extend parallel to the forward/backward direction. When forward/backward member 11 moves in the forward/backward direction, protruding portion 26 moves along the guiding groove, and guides forward/backward-member-side member 21 such that forward/backward-member-side member 21 slides in the forward/backward direction of forward/backward member 11 in case 4.

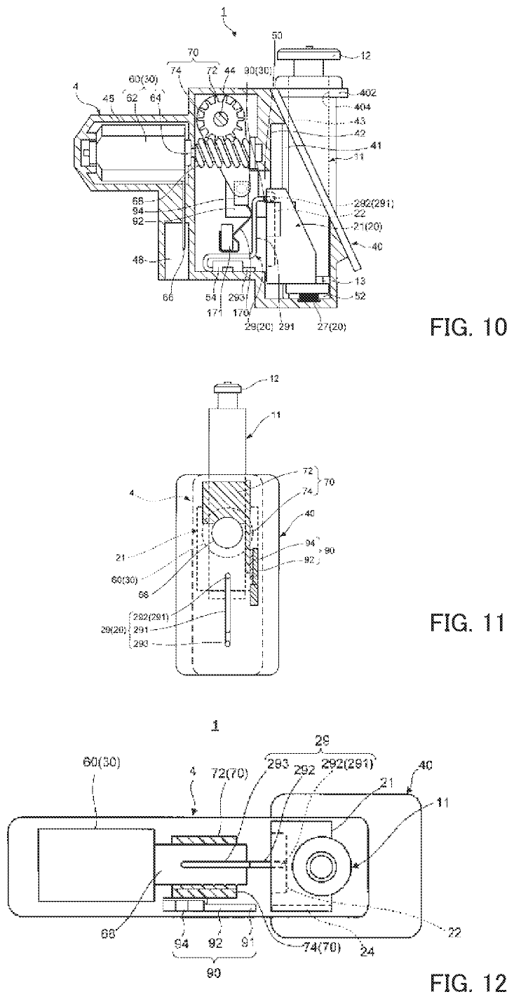

Fourth plate-shaped section 21d of forward/backward-member-side member 21 is provided with recess portion 24 that is engaged with restriction member 90 to restrict the movement of forward/backward-member-side member 21 in the direction along the central axis of forward/backward member 11. In the present embodiment, recess portion 24 is provided in fourth plate-shaped section 21d and opens toward first plate-shaped section 21a. Engaging section 91 (see FIG. 9 and FIG. 10) of restriction member 90 enters recess portion 24 from the side of first plate-shaped section 21a. Note that, regarding recess portion 24, the length of forward/backward movement of forward/backward member 11 to be restricted by engaging section 91 of restriction member 90 can be changed depending on the axial position of the surface of fourth plate-shaped section 21d which delimits recess portion 24 on the backward-direction side. In the present embodiment, recess portion 24 is provided in a position where engaging section 91 is inserted to recess portion 24 when forward/backward member 11 is located in the backward position. Recess portion 24, which is the engaged section, is provided in forward/backward-member-side member 21 on a lateral side of guiding section 22 in the thickness direction of case 4.

First plate-shaped section 21a of forward/backward-member-side member 21 is located on the side opposite to forward/backward member 11 with respect to proximate wall portion 40. First plate-shaped section 21a is disposed to face engaging section 91 of restriction member 90. First plate-shaped section 21a has guiding section 22 that is a plate-shaped member with protrusions and recesses formed.

[Guiding Section 22]

Guiding section 22 guides movement of forward/backward-member-side member 21. Guiding section 22 is provided on the side opposite to forward/backward member 11 with respect to proximate wall portion 40. Guiding section 22 is provided in first plate-shaped section 21a of forward/backward-member-side member 21 in the present embodiment. Guiding section 22 regulates an operation of relative movement between bending pin 29 and forward/backward-member-side member 21.

Guiding section 22 is a so-called heart cam provided in forward/backward-member-side member 21 and includes a circumferentially extending recess portion in a plate-shaped surface, and guides extending-portion end portion 292 of bending pin 29 along the circumferentially extending recess portion. The circumferentially extending recess portion is provided with steps at the bottom thereof, and extending-portion end portion 292 of bending pin 29 is guided in a descending direction of the steps. Extending-portion end portion 292 of bending pin 29 is disposed so as to press the bottom of the recess portion of guiding section 22. Thus, extending-portion end portion 292 of bending pin 29 is guided so as to circumferentially travel in one direction along the circumferentially extending recess portion in guiding section 22. When extending-portion end portion 292 of bending pin 29 is in backward-side position 22b in the circumferentially extending recess portion of guiding section 22, forward/backward member 11 is in the forward position where forward/backward member 11 has moved forward to the outer side of case 4. When extending-portion end portion 292 of bending pin 29 is in the forward-side position (second position) in the circumferentially extending recess portion of guiding section 22, that is, when extending-portion end portion 292 is engaged with V-shaped portion 22a, which is a valley portion at the center of a letter “M” shape, forward/backward member 11 is located in the backward position where forward/backward member 11 has moved backward to the inner side of case 4.

Of the positions of extending-portion end portion 292 of pin 29, the backward-side position in the circumferentially extending recess portion of guiding section 22 corresponds to an example of a first position. In addition, of the positions of extending-portion end portion 292 of bending pin 29, the forward-side position in the circumferentially extending recess portion of guiding section 22 (specifically, the position at which extending-portion end portion 292 is engaged with V-shaped portion 22a) corresponds to an example of the second position. As described above, forward/backward member 11 is moved to the forward position or the backward position, respectively, when the guided section is guided to the first position or the second position in guiding section 22.

The circumferentially extending recess portion of guiding section 22 has a path portion curved in a letter “M” shape on the forward side in the forward/backward direction of forward/backward member 11. When extending-portion end portion 292 of bending pin 29 is guided along this path portion, forward/backward member 11 is moved backward almost to the end, then slightly moves forward and temporarily stops there. Extending-portion end portion 292 of bending pin 29 at this time is situated at V-shaped portion 22a, which is the valley portion of the letter “M” shape. When forward/backward member 11 is moved backward almost to the end one more time, extending-portion end portion 292 of bending pin 29 moves after coming off V-shaped portion 22a, and forward/backward member 11 moves forward to the forward position with this movement.

[Bending Pin 29 (Guided Section)]

Forward/backward member 11 is moved to the forward position or the backward position, respectively, when bending pin 29 is guided to the first position or the second position in guiding section 22. In the present embodiment, bending pin 29 is disposed on the side opposite to forward/backward member 11 with respect to proximate wall portion 40. In the present embodiment, bending pin 29 is disposed on the side opposite to forward/backward member 11 with respect to proximate wall portion 40 so as to extend in a direction in which forward/backward member 11 and proximate wall portion 40 are arranged.

Bending pin 29 is provided in a predetermined position with respect to case 4. More specifically, bending pin 29 is provided so as to have a portion (here, bent portion 291 which will be described later) whose relative position to case 4 does not change.

Bending pin 29 has fixed portion 293 at least partially fixed to case 4 and extending portion 291 extending to guiding section 22.

Bending pin 29 has fixed portion 293 and extending-portion end portion 292 at opposite ends, respectively. Fixed portion 293 at one end (base end) is attached to guided-section holding section 54 of case 4.

In the present embodiment, fixed portion 293 is fixed to guided-section holding section 54 with one end portion being pointed toward spring housing section 52 and other end portion 293a being pointed toward lead-out hole 48.

Extending portion 291 of bending pin 29 is disposed on the side opposite to forward/backward member 11 with respect to proximate wall portion 40 so as to extend from the side of lead-out hole 48 toward forward/backward member 11.

Extending portion 291 extends from other end portion 293a of fixed portion 293 toward guiding section 22 of forward/backward-member-side member 21 attached to forward/backward member 11.

Extending-portion end portion 292 at the other end (leading end) is a part of extending portion 291 of bending pin 29 that is an example of the guided section guided by guiding section 22 of forward/backward-member-side member 21.

Extending portion 291 and extending-portion end portion 292 of bending pin 29 are disposed on the side opposite to forward/backward member 11 with respect to proximate wall portion 40 and in a position where extending portion 291 and extending-portion end portion 292 overlap, in the thickness direction, a region in which restriction member 90 held by link holding section 50 is movable.

Bending pin 29 may be elastic as long as it is so rigid as to allow control of the forward/backward movement of forward/backward member 11. Bending pin 29 is disposed such that one end of bending pin 29 is fixed to guided-section holding section 54 and extending-portion end portion 292 on the other end side is pressed against guiding section 22.

In the present embodiment, bending pin 29 is composed of an elastically deformable member and is in such a state that extending portion 291 is bent at fixed portion 293 to extend from there to guiding section 22, and extending-portion end portion 292 at the leading end is pressed onto guiding section 22 of forward/backward-member-side member 21.

Note that, bending pin 29 may be biased and pressed onto guiding section 22 by guided-section biasing member 170 that biases bending pin 29 being the guided section such that bending pin 29 does not move away from a predetermined position of guiding section 22. Guided-section biasing member 170 is composed, for example, of a leaf spring. Guided-section biasing member 170, at one end side, makes contact with extending portion 291 of bending pin 29 to bias extending portion 291 toward guiding section 22 and is, at the other end side, supported by supporting section 171. Supporting section 171 withstands a reaction force caused when guided-section biasing member 170 biases guiding section 22, and supports the biasing member such that the biasing member remains in a predetermined position in case 4.

In bending pin 29, extending portion 291 from fixed portion 293 to extending-portion end portion 292 has a length sufficient for extending-portion end portion 292 to always press guiding section 22 through elastic deformation. Specifically, extending portion 291 includes first side portion 291a that is folded back on the side of forward/backward member 11 from other end portion 293a of fixed portion 293 disposed to extend away from forward/backward member 11, and second side portion 291b extending from the end portion of the first side portion along the forward/backward direction of forward/backward member 11 in a direction away from fixed portion 293 and connected to extending-portion end portion 292.

As described above, in the present embodiment, guided section 22 and bending pin 29 as an example of the guided section guided by guiding section 22 are disposed on the side opposite to forward/backward member 11 with respect to proximate wall portion 40 and between forward/backward member 11 and drive section 60. Moreover, guiding section 22 is disposed on the side opposite to forward/backward member 11 with respect to proximate wall portion 40 so as to open toward link holding section 50, and extending-portion end portion 292 of bending pin 29 is guided to guiding section 22. Further, in the present embodiment, a third side portion connecting first side portion 291a to second side portion 291b and extending in substantially the same direction as the extending portion is provided. This third side portion is disposed in case 4 so as to extend in the same direction as restriction-member main body 92.

[Spring 27]

Spring 27 biases forward/backward member 11 in the axial direction of forward/backward member 11, in particular, in the forward direction of forward/backward member 11. As illustrated in FIG. 5 and FIG. 6, one end of spring 27 is held to the end portion of forward/backward member 11 on the backward position side, and the other end of spring 27 is held to a case-side spring holding section of spring housing section 52 of case 4. With this configuration, spring 27 exerts a repulsive force in the forward direction of forward/backward member 11 on forward/backward member 11 and forward/backward-member-side member 21 which moves together with forward/backward member 11. The forward movement of forward/backward member 11 biased in the forward direction by spring 27 is regulated when forward/backward-member-side member 21 that is fitted to be relatively rotatable in case 4 comes into contact with the inner wall surface around through-hole 43 of proximate wall portion 40 in the present embodiment.

As described above, guiding section 22, and bending pin 29, which is an example of the guided section, serve a role of regulating the operation of relative movement between forward/backward-member-side member 21 and case 4 in forward/backward position control mechanism 20 that controls the forward/backward movement of forward/backward member 11.

Note that, the motion of forward/backward member 11 in the backward direction is caused by an external force, and the motion of forward/backward member 11 in the forward direction is caused by the biasing force of spring 27. Note that, the configuration of forward/backward position control mechanism 20 that controls the forward/backward movement of forward/backward member 11 is not limited to the configuration described above as long as the relative position between forward/backward member 11, forward/backward-member-side member 21, and spring 27 is not different from that in the present embodiment.

[Configuration of Restriction Mechanism 30]

In restriction mechanism 30, drive section 60 is driven to rotate rotary gear 72 so as to rotate swing member 74, and the rotation of swing member 74 then causes engaging section 91 of restriction member 90 to be engaged with forward/backward member 11 (forward/backward-member-side member 21 provided on forward/backward member 11 in the present embodiment), so that forward/backward member 11 is locked.

[Drive Section 60]

Drive section 60 generates a driving force that moves restriction member 90. Drive section 60 includes drive-section main body 62 for generating the driving force, and drive shaft 64 that is rotated by the driving force of drive-section main body 62. In the present embodiment, a motor is applied as drive section 60. In the present embodiment, terminal 66 for power supply is connected to drive section 60.

Drive-section main body 62 is a motor main body that drives by using the power supplied via terminal 66, and drive shaft 64 is an output shaft of the motor. Drive section 60 may, for example, drive by itself to cause restriction member 90 to perform a lock operation, but in the case of application to a vehicle, for example, the lock operation is performed in conjunction with locking by a key operation of the vehicle. In the present embodiment, drive shaft 64 and restriction-member main body 92 are disposed so as to extend in substantially the same direction.

Terminal 66 is disposed in a position communicating with lead-out hole 48.

In the present embodiment, terminal 66 is adjacently disposed on the backward position side of forward/backward member 11 with respect to drive section 60. Terminal 66 is also disposed with one end being connected to drive-section main body 62 of drive section 60 and the other end being pointed in the opening direction of lead-out hole 48.

Drive shaft 64 protruding from drive-section main body 62 is disposed in the direction intersecting the direction in which forward/backward member 11 extends (equivalent to the forward/backward direction). In the present embodiment, drive section 60 is held by drive-section-main-body holding section 45 and is thus housed in case 4 such that drive section 60 is adjacent to link holding section 50 in case 4 and the respective axes (see FIG. 5 and FIG. 6) of drive section 60 and link holding section 50 are substantially orthogonal to each other.

In the present embodiment, drive section 60 is disposed such that drive shaft 64, which is the output shaft of the motor, points toward forward/backward member 11 and drive-section main body 62 and forward/backward member 11 as seen in the width direction are overlappingly arranged.

Drive section 60 is adjacent to the link mechanism in case 4 and is disposed above the bottom surface of the bottom portion of case 4.

Drive section 60 includes a drive-section shoulder space in the form of a cut-out space around drive shaft 64 on the axial side of the surface of drive-section main body 62 situated on the side toward which drive shaft 64 protrudes. The drive-section shoulder space as seen in front view is a recessed space formed in a rectangle enclosing drive-section main body 62 and drive shaft 64 so as to extend from the outer edge of drive-section main body 62 toward the leading end of drive shaft 64.

Worm gear 68 is fixed to drive shaft 64 such that driving of drive section 60 causes worm gear 68 to rotate. Rotating worm gear 68 meshes with rotary gear 72 to cause rotary gear 72 to rotate

[Rotary Gear 72 and Swing Member 74]

Rotary gear 72 and swing member 74 transmit the driving force of drive section 60 to restriction member 90. Rotary gear 72 and swing member 74 are connected to worm gear 68 of drive shaft 64 and transmit the driving force of drive section 60, i.e., a rotation force of drive shaft 64 to restriction member 90 so as to move restriction member 90.

Rotation of drive shaft 64 causes rotary gear 72 to rotate about a rotational axis that is a direction substantially orthogonal to drive shaft 64. Rotation of rotary gear 72 causes swing member 74 to rotate about the rotational axis that is the direction substantially orthogonal to drive shaft 64.

In the present embodiment, rotary gear 72 is integrated with swing member 74 into transmission member 70.

Transmission member 70 is provided to freely rotate about spindle 44. Spindle 44 is the rotational axis extending in the direction substantially orthogonal to drive shaft 64. In the present embodiment, spindle 44 is disposed on the forward position side of forward/backward-member-side member 21 with respect to drive shaft 64. In transmission member 70, rotary gear 72 and swing member 74 rotate about spindle 44.

In transmission member 70, swing member 74 is provided to extend toward the backward position side of forward/backward member 11 from rotary gear 72 rotating around spindle 44.

Rotary gear 72 is a helical gear in the present embodiment and meshes with worm gear 68, and rotates about spindle 44 being orthogonal to drive shaft 64 that is a shaft of worm gear 68.

Rotary gear 72 is disposed in a plane containing worm gear 68 and drive shaft 64 and meshes with worm gear 68.

Swing member 74 is provided in transmission member 70 to protrude from a portion overlapping with rotary gear 72 on the side of the bottom surface of case 4 in the direction of spindle 44.

Swing member 74 is provided to extend across drive shaft 64 and on the side of the bottom surface of case 4 more closely than drive shaft 64 extends.

In the present embodiment, swing member 74 is composed of a plate-shaped member, and is, at the tip end portion of this plate-shaped member, freely turnably connected to restriction member 90 disposed on the side of the bottom surface more closely than swing member 74 is.

In the present embodiment, swing member 74 is disposed in a plane which is situated on the side of the bottom surface of case 4 and is parallel to the plane including worm gear 68 and drive shaft 64 and which includes drive-section main body 62.

Swing member 74 is disposed so as to be freely turnable about spindle 44 of link holding section 50. Accordingly, swing member 74 swings along worm gear 68 and drive shaft 64 in a region on the side of the bottom surface of case 4 parallel to the plane including worm gear 68 and drive shaft 64.

The plane formed by the swing trajectory of swing member 74 is substantially parallel to a directional axis in which engaging section 91 of restriction member 90 and extending-portion end portion 292 of extending portion 291 of bending pin 29 that is an example of the guided section extend.

In the present embodiment, rotary gear 72 included in transmission member 70 is disposed such that a part of rotary gear 72 is positioned in the drive-section shoulder space formed by drive-section main body 62 and drive shaft 64, the so-called recessed portion. Thus, the length of the arrangement in back-and-forth movement device 1 in which drive section 60 is arranged orthogonally with respect to forward/backward member 11, that is, the length of case 4 in the width direction can be shorter as compared with an arrangement in which rotary gear 72 is disposed outside of the rectangle enclosing drive-section main body 62 and drive shaft 64, i.e., outside of the recessed portion.

In the present embodiment, rotary gear 72 and swing member 74 may be provided in any way as long as a part of rotary gear 72 is disposed in the drive-section shoulder space, and the function of transmitting the driving force of drive section 60 to restriction member 90 can be fulfilled.

Further, in the present embodiment, transmission of the driving force from drive shaft 64 of drive section 60 to restriction member 90 is made to restriction member 90 via worm gear 68 attached to drive shaft 64, and transmission member 70 including rotary gear 72 and swing member 74. For this reason, when drive section 60 is not driving, drive section 60 is restrained from rotating by transmission member 70 via drive shaft 64. Thus, rotation about drive shaft 64 can be regulated without a need to provide drive section 60 itself with a lock mechanism which restricts rotation of drive shaft 64.

[Restriction Member 90]

Restriction member 90 illustrated in FIG. 5 and FIG. 6 brings forward/backward member 11 movable in the axial direction into the restricted state in which the movement of forward/backward member 11 in the forward/backward direction (here, in the axial direction) is restricted. As illustrated in FIG. 10, the restricted state is a state where forward/backward member 11 is held in a state where forward/backward member 11 is located in the backward position and restricted from moving forward and backward. Restriction member 90 is provided so as to be movable between a restricted position where forward/backward member 11 is in the restricted state and a release position where the restricted state is released.

In the present embodiment, in the restricted position of forward/backward member 11, restriction member 90 is engaged with forward/backward-member-side member 21 to bring forward/backward member 11 into the restricted state, that is, into a locked state. In the present embodiment, by way of an example, the restricted position is the same position as the backward position where forward/backward member 11 is held by forward/backward position control mechanism 20. Therefore, when forward/backward position control mechanism 20 causes forward/backward member 11 to be located in the backward position, restriction member 90 brings forward/backward member 11 into the restricted state to restrict movement to the forward position through forward/backward position control mechanism 20. Note that, the restricted position may be different from the backward position where forward/backward member 11 is held by forward/backward position control mechanism 20, and the movement of forward/backward member 11 along the way from the backward position to the forward position before release of the latched state between latching section 12 and latched section 140 may also be restricted. Note that, the restricted state in which the forward/backward movement is restricted is representatively a state in which both the movement in the forward direction and the movement in the backward direction are restricted, as will be described later. Meanwhile, as a variation, the restricted state may also be a state in which only one of the movement in the forward direction and the movement in the backward direction is restricted.

Restriction member 90 includes engaging section 91 that is to be engaged, in the restricted position, with recess portion 24 provided in forward/backward-member-side member 21, and conversion mechanism section 94 that changes the rotation of swing member 74 into a linear motion. In restriction member 90, the rotation of swing member 74 is converted into linear motion by conversion mechanism section 94, so that engaging section 91 linearly moves.

In the present embodiment, restriction member 90 is formed in a flat plate shape and includes restriction-member main body 92 connected to swing member 74 as illustrated in FIG. 5 and FIG. 6. Engaging section 91 is provided so as to extend out from restriction-member main body 92 in a direction intersecting the forward/backward direction of forward/backward member 11 and is capable of being engaged with forward/backward member 11, i.e., recess portion 24 of forward/backward-member-side member 21. Conversion mechanism section 94 is a hole portion provided in restriction-member main body 92.

As illustrated in FIG. 9 to FIG. 11, engaging section 91 of restriction member 90 extends substantially parallel to extending portion 291 of bending pin 29 (specifically, the directional axis of extending-portion end portion 292) on the side opposite to forward/backward member 11 with respect to proximate wall portion 40. In the present embodiment, engaging section 91 extends between drive section 60 and forward/backward member 11 from the side of drive section 60 toward the side of forward/backward-member-side member 21.

In the present embodiment, on the side opposite to forward/backward member 11 with respect to proximate wall portion 40, engaging section 91 extends substantially parallel to extending portion 291 of bending pin 29 that is an example of the guided section, and engaging section 91 and extending portion 291 are arranged substantially parallel to each other.

Restriction member 90 is slidably held by link holding section 50 of case 4. Link holding section 50 includes a region that is situated on/above the bottom surface inside case 4 and closer to the side of the bottom surface of case 4 than the swing region of swing member 74 is to the side of the bottom surface of case 4 and in which restriction-member main body 92 is slidable, and a region linearly extending in the same direction as the direction in which engaging section 91 extends out. In each of the regions, restriction portion 90 is slidably disposed. In particular, in the region linearly extending in the same direction as the direction in which engaging section 91 extends out, engaging section 91 slidingly moves in the same direction.

In conversion mechanism section 94 of restriction-member main body 92, the shaft portion provided at the tip end portion of swing member 74 is loosely fitted in the hole portion of conversion mechanism section 94 and is driven by the rotational motion of swing member 74, so that restriction member 90 is moved in the extending direction of engaging section 91. Restriction member 90 is pressed or pulled in the linear direction by swing member 74, and such a pressing force is transmitted to restriction-member main body 92, so that restriction-member main body 92 moves and the movement of restriction-member main body 92 is followed by the linear motion of engaging section 91.

Note that, as described above, in the present embodiment, transmission member 70 may have a cam mechanism for rotation about an axis vertical to the axis of drive shaft 64 of drive section 60, and conversion mechanism section 94 may have a loose fitting mechanism so that the rotation of rotary gear 72 of transmission member 70 allows swing member 74 to move in the direction vertical to the moving direction of restriction member 90.

When forward/backward member 11 is in the backward position and restriction member 90 moves by an amount equal to or greater than a predetermined amount, engaging section 91 of restriction member 90 enters recess portion 24 of forward/backward-member-side member 21 and is engaged with recess portion 24 which is the engaged section, so that forward/backward member 11 is brought into the restricted state in which the forward/backward movement of forward/backward member 11 is restricted. Note that the leading end of engaging section 91 may have a tapered portion for ease of insertion into recess portion 24.

The position of restriction member 90 in FIG. 5 and FIG. 6 is the release position for releasing the restricted state of forward/backward member 11. When restriction member 90 is in the release position, forward/backward member 11 becomes movable forward and backward, and FIG. 5 illustrates a state where forward/backward member 11 has fully moved in the forward direction and FIG. 6 illustrates a state where forward/backward member 11 has fully moved in the backward direction.

Note that, a configuration for bringing forward/backward member 11 into the restricted state is not limited to the configuration in which engaging section 91 of restriction member 90 enters into recess portion 24 of forward/backward-member-side member 21, but various engagement structures may be applied. For example, a configuration may also be employed in which forward/backward member 11 is provided with a protruding portion and restriction member 90 is provided with a recess portion, and when restriction member 90 is located in the restricted position, the recess portion is engaged with the protruding portion so that forward/backward member 11 is brought into the restricted state.

[Operation of Back-and-Forth Movement Device 1]

In back-and-forth movement device 1, as illustrated in FIG. 5, when forward/backward member 11 is in the forward position, latching section 12 is directed in a direction in which latching onto latched section 140 of fuel lid 120 is released. Further, restriction member 90 is disposed in the release position via rotary gear 72 by control of drive section 60. At this time, forward/backward member 11 receives a repulsive force of spring 27 via forward/backward-member-side member 21 and is thus biased in the forward direction. Further, extending-portion end portion 292 of bending pin 29 is located on the backward side on a circumferentially extending path of guiding section 22 and restricts forward/backward member 11 from further moving forward. In this state, when an external force in the backward direction is applied to forward/backward member 11, forward/backward member 11 moves backward. During the backward movement, forward/backward member 11 moves to the backward position while helical groove 14 in forward/backward member 11 is guided by the protrusion of case 4 such that a trajectory of the movement of forward/backward member 11 along which the leading end of forward/backward member 11 is to rotate is generated. Thus, forward/backward member 11 rotates in the rotation direction about the axial core thereof.

When forward/backward member 11 is moved to the backward position by the external force, extending-portion end portion 292 of bending pin 29 is located on the forward side on the circumferentially extending path of guiding section 22 and temporarily holds forward/backward member 11 such that forward/backward member 11 does not move forward as illustrated in FIG. 6. Specifically, bending pin 29 is engaged with V-shaped portion 22a of guiding section 22 as illustrated in FIG. 9. Further, latching section 12 of forward/backward member 11 is directed in the direction in which latching section 12 is latched onto latched section 140 of fuel lid 120.

In the state where forward/backward member 11 is moved backward, worm gear 68 is rotated and rotary gear 72 that meshes with this worm gear 68 is rotated by the control of drive section 60. This rotation of rotary gear 72 causes swing member 74 that is integrated with rotary gear 72 into transmission member 70 to turn as illustrated in FIG. 10. The rotation of swing member 74 is transmitted to restriction member 90 via conversion mechanism section 94 connected to the tip end portion of swing member 74, and accordingly, restriction member 90 moves to the restricted position. Along with this movement, engaging section 91 is engaged with recess portion 24 and restricts the slide movement of forward/backward-member-side member 21. The forward/backward movement of forward/backward member 11 is thus restricted.

Further, when worm gear 68 is rotated and rotary gear 72 that meshes with this worm gear 68 is reversely rotated by the control of drive section 60 in the state where forward/backward member 11 is moved backward, swing member 74 turns as well. The rotation of swing member 74 is transmitted to restriction member 90 via conversion mechanism section 94 connected to the tip end portion of swing member 74. Thus, restriction member 90 moves to the release position, so that the restriction of slide movement of forward/backward-member-side member 21 is released, and the restriction of forward/backward movement of forward/backward member 11 is also released.

Note that, when an external force in the backward direction is applied to forward/backward member 11 in the state where the restricted state of forward/backward movement of forward/backward member 11 is released, extending-portion end portion 292 of bending pin 29 moves to a path portion on the circumferentially extending path of guiding section 22 where extending-portion end portion 292 of bending pin 29 is to be guided from the forward side toward the backward side. When the application of the external force on forward/backward member 11 is stopped, the repulsive force of spring 27 causes forward/backward-member-side member 21 to slide so as to move forward/backward member 11 to the forward position.

[Effects of Back-and-Forth Movement Device 1]

According to back-and-forth movement device 1 of the present embodiment, guiding section 22 is provided on the side opposite to forward/backward member 11 with respect to proximate wall portion 40 as illustrated in FIG. 9, FIG. 11, and FIG. 12. Further, extending portion 291 of bending pin 29 which is an example of the guided section guided by guiding section 22 extends substantially parallel to engaging section 91 of restriction member 90 on the side opposite to forward/backward member 11 with respect to proximate wall portion 40. As illustrated in FIG. 11, bending pin 29, forward/backward member 11, guiding section 22, drive section 60, and rotary gear 72 are arranged in back-and-forth movement device 1 to overlap one another in the forward/backward direction.

It is thus possible to make back-and-forth movement device 1 thinner in the thickness direction than in a configuration in which the guided section to be guided by guiding section 22 is disposed on the upper side of case 4, i.e., in a thickness-wise position in back-and-forth movement device 1.

Further, as illustrated in FIG. 11 and FIG. 12, forward/backward member 11 and drive section 60 are arranged such that their axes are substantially orthogonal to each other, and are housed in case 4 to be located in the same layer in the thickness direction of back-and-forth movement device 1. In addition, swing member 74 that, together with rotary gear 72, transmits the rotation of drive section 60 to restriction member 90 is held by link holding section 50 on the side opposite to forward/backward member 11 with respect to proximate wall portion 40, and is disposed between forward/backward member 11 and drive section 60. In link holding section 50, a slide movement plane of restriction member 90 and a swing trajectory plane of swing member 74 are successively arranged in layers from the side of the bottom surface of case 4, and a layer including worm gear 68, rotary gear 72, and bending pin 29 is disposed above the layer of the swing trajectory plane overlappingly. These turn, swing, and movement regions are also arranged to be stacked on one another and to overlap one another in the thickness direction.

It is thus possible to achieve miniaturization of back-and-forth movement device 1 itself, so as to house back-and-forth movement device 1 even in a narrow housing space which is thin in the thickness direction.

Further, forward/backward member 11 is provided so as to be capable of moving forward and backward from the inside of case 4 through proximate wall portion 40 in a direction inclined with respect to proximate wall portion 40. Thus, even when the attachment location of back-and-forth movement device 1 is inclined with respect to the forward/backward direction as illustrated in FIG. 1, forward/backward member 11 can be attached in accordance with the inclination at the attachment location and can be moved forward and backward in a suitable direction.

In drive section 60, a part of rotary gear 72 is disposed in the recessed portion formed by drive-section main body 62 and drive shaft 64, that is, in the drive-section shoulder space. Thus, further miniaturization reducing the length in the direction parallel to forward/backward member 11 is achieved.

Further, forward/backward-member-side member 21 includes guiding section 22 for controlling the forward/backward movement of forward/backward member 11. It is thus possible to easily provide a structure for controlling the forward/backward movement of forward/backward member 11 even with the configuration in which forward/backward member 11 moves forward and backward while rotating.

Note that, the present invention can be variously modified without being limited to the embodiment described above. For example, in the embodiment described above, the configuration in which the restriction member rectilinearly moves has been presented as an example. However, a configuration in which the restriction member that makes circular motion and is engaged with the forward/backward-member-side member may also be employed.

### INDUSTRIAL APPLICABILITY

The fuel lid opening/closing apparatus has been presented as the opening/closing apparatus by way of example. However, the back-and-forth movement device according to the present invention can similarly be applied in a variety of flap-type opening/closing apparatuses. Further, the back-and-forth movement device may be mounted into a variety of apparatuses without being limited to the opening/closing apparatus.

### REFERENCE SIGNS LIST

1 Back-and-forth movement device
2 Vehicle body
2a Filler opening portion
2b Step
4 Case
5 Cover
11 Forward/backward member
12 Latching section
13 Annular groove
14 Helical groove
20 Forward/backward position control mechanism
21 Forward/backward-member-side member
22 Guiding section
22a V-shaped portion
23 Fitting section
24 Recess portion (engaged section)
25 Curved surface
26 Protruding portion
27 Spring
29 Bending pin (guided section)
30 Restriction mechanism
41 Forward/backward-member holding section
43, 404 Through-hole
44 Spindle
45 Drive-section-main-body holding section
50 Link holding section
52 Spring housing section
54 Guided-section holding section
60 Drive section
62 Drive-section main body
64 Drive shaft
68 Worm gear
70 Transmission member
72 Rotary gear
74 Swing member
90 Restriction member
91 Engaging section
92 Restriction-member main body
94 Conversion mechanism section
100 Opening/closing apparatus
110 Box main body
112 Opening
118 Flange
120 Fuel lid
130 Hinge
140 Latched section
160 Screw cap
170 Guided-section biasing member
171 Supporting section

What is claimed is:

1. A back-and-forth movement device, comprising:
a case;
a drive section;
a forward/backward member capable of moving forward and backward with respect to the case;
a forward/backward position control mechanism that performs control such that the forward/backward member moves forward to a forward position or backward to a backward position, the forward position being where the forward/backward member has moved forward with respect to the case, the backward position being where the forward/backward member has moved backward with respect to the case; and
a restriction member that brings the forward/backward member into a restricted state in which forward/backward movement is restricted; wherein
the forward/backward member is provided in the case so as to move forward and backward while rotating relatively with respect to the case,
the forward/backward position control mechanism includes a forward/backward-member-side member, a guiding section, and a guided section, the forward/backward-member-side member being provided on the forward/backward member so as to be fitted rotatably relative to the forward/backward member, the guiding section being configured to regulate an operation of relative movement between the forward/backward-member-side member and the case, the guided section being guided by the guiding section,
the forward/backward member is moved to the forward position or the backward position, respectively, when the guided section is guided to a first position or a second position in the guiding section, and
the restriction member is provided so as to be movable to a restricted position where the forward/backward member is brought into the restricted state and to a release position where the restricted state is released, the restriction member being configured to be engaged with the forward/backward-member-side member in the restricted position to bring the forward/backward member into the restricted state,
the guiding section is provided in the forward/backward-member-side member,
the guided section includes a fixed portion at least partially fixed to the case, and an extending portion extending to the guiding section,
the restriction member includes an engaging section that is engaged with an engaged section in the restricted position, the engaged section being provided in the forward/backward-member-side member;
the case partly includes a proximate wall portion that is in proximity to the forward/backward member,
the guiding section is provided on a side opposite to the forward/backward member with respect to the proximate wall portion, and
the engaging section of the restriction member and the extending portion of the guided section extend substantially parallel to each other on the side opposite to the forward/backward member with respect to the proximate wall portion.

2. The back-and-forth movement device according to claim 1, further comprising:
a rotary gear that meshes with a gear provided on a drive shaft of the drive section, and is rotated by rotation of the drive shaft; and
a swing member that is swung by rotation of the rotary gear, wherein
the swing member and the restriction member constitute a link mechanism in which the rotation of the rotary gear causes the restriction member to move rectilinearly,
a plane formed by a swing trajectory of the swing member is substantially parallel to a directional axis along which the engaging section of the restriction member and the extending portion of the guided section extend.
